(19) United States
(12) Patent Application Publication
(10) Pub. No.: US 2026/0134349 A1
(43) Pub. Date: May 14, 2026

(54) METHOD AND DEVICE FOR EVALUATING A DATA SET

(71) Applicant: Robert Bosch GmbH, Stuttgart (DE)

(72) Inventors: Konrad Groh, Stuttgart (DE); Matthias Woehrle, Bietigheim-Bissingen (DE)

(21) Appl. No.: 19/386,696

(22) Filed: Nov. 12, 2025

(30) Foreign Application Priority Data
Nov. 14, 2024 (DE) 10 2024 210 976.2

(51) Int. Cl. G06N 20/00

(52) U.S. Cl. CPC G06N 20/00

(57) ABSTRACT

A computer-implemented method for ascertaining a quality value of a data set for training/testing a machine learning system. The data set includes a plurality of inputs and, in each case, an output corresponding to a respective input. The input characterizes at least one value of a sensor signal, and the output includes a classification and/or a regression result with respect to the input. The method includes: ascertaining a binning of the values of the sensor signals of the plurality of the inputs, inputs being assigned to different bins of the binning according to the values of the sensor signals encompassed by the inputs; assigning the outputs to the bins according to the assignment of the inputs corresponding to the outputs; ascertaining in each case a first quality value for a plurality of bins of the binning. The first quality value characterizes an average or median of second quality values.

### FIELD

The present invention relates to ascertaining a quality value of a data set for training and/or testing a machine learning system, a method for training a machine learning system, a training system, a computer program, and a machine-readable storage medium.

### BACKGROUND INFORMATION

Zhao et al. “Virtual Sensor for Real-Time Bearing Load Prediction Using Heterogeneous Temporal Graph Neural Networks,” Apr. 2, 2024, arxiv.org/pdf/2404.02304 describes an average global metric for testing virtual sensors.

Breck et al. “The ML Test Score: A Rubric for ML Production Readiness and Technical Debt Reduction,” 2017, in IEEE International Conference on Big Data describes certain concerns in deploying reliable, production-level machine learning systems.

### SUMMARY

The quality of technical machine learning systems for processing real-world measurements (also known as virtual sensors) can be further improved by using high-quality data sets for training. Here, quality can be understood in particular as the annotation of inputs by desired outputs, in other words, the quality of the annotation of the data set. Evaluating the quality of a data set is therefore crucial for the development of robust and reliable machine learning systems. Previous approaches to verifying the quality of a data set often focus on global metrics that summarize the entire data set, such as the average error across all data points. However, these global metrics may not adequately depict the quality of annotation in specific regions of the data set. For example, a data set might have good average annotation quality but be incorrectly annotated in certain regions that are critical for the application. Therefore, a more detailed evaluation is needed that takes into account the quality of the data set in different Segments of the input space.

The present invention provides a method for evaluating the quality of a data set that addresses the disadvantages of the previous approaches. Advantageously, the method allows the quality of the data set to be assessed based on its “weakest points” in order to ensure that the machine learning system trained thereon receives well-annotated data across all regions of the data set. Advantageously, the inventors were able to find that identifying and evaluating the “weakest points” of a data set by considering the minimum quality in sub-regions of the input space allows for a more meaningful evaluation of the quality of the data set.

The present invention is based on a “binning” approach, in which an input space spanned by the sensor values of the data set is divided into discrete regions (bins) based on the values of the sensor signals. For each bin, a quality value is calculated that quantifies the agreement between the outputs present in the data set and the desired outputs in this bin. The quality value can therefore be understood as meaning that a numerically smaller quality value represents a better quality of a data set than a numerically larger quality value. In other words, the lower the quality value, the “better” the data set. The quality value of the entire data set is ascertained as a maximum quality value across all bins or as a quantile of the quality values of the bins. This approach makes a differentiated evaluation of the quality of the data set possible and identifies the regions of the input space where the data set is weakest. Advantageously, the regions with the lowest quality value provide indications of where additional data are needed or where the quality of the existing data needs to be improved. Particularly in the development of machine learning systems for specific technical applications, such as image processing, the method can be used advantageously to ensure that a training data set contains the necessary data, or that a test data set contains a sufficient number of data to allow meaningful results.

A further advantage of the method of the present invention is that the same method can also be used to evaluate the quality of an output from a machine learning system.

In a first aspect, the present invention relates to a computer-implemented method for ascertaining a quality value of a data set for training and/or testing a machine learning system, wherein the data set comprises a plurality of inputs and in each case an output corresponding to a respective input, wherein the input characterizes at least one value of a sensor signal, and the output comprises a classification and/or a regression result with respect to the input. According to an example embodiment of the present invention, the method comprises the following steps:
Ascertaining a binning of the values of the sensor signals of the plurality of the inputs, wherein inputs are assigned to different bins of the binning according to the values of the sensor signals encompassed by the inputs;
Assigning the outputs to the bins according to the assignment of the inputs corresponding to the outputs.
Ascertaining in each case a first quality value for a plurality of bins of the binning, preferably all bins of the binning, wherein the first quality value characterizes an average or median of second quality values, wherein, in each case, a second quality value characterizes a deviation with respect to an output assigned to the bin from correspondingly desired outputs;
Ascertaining the quality value of the data set, wherein the quality value corresponds to a numerically largest quality value of the first quality values or a quantile of the first quality values.

In the context of the present invention, the term “machine learning system” can be understood as a computer system that is capable of learning from data. It is based on algorithms that recognize patterns and relationships in data and use them to make predictions or decisions. The machine learning system is optimized by training with sample data, wherein the parameters of the system are adapted such that prediction accuracy is maximized. Embodiments of machine learning systems include in particular neural networks, support vector machines, decision trees, Bayesian networks, or k-nearest neighbor classifiers/regressors. The selection of the specific machine learning system depends on the specific application and the properties of the data. In the context of this invention, the machine learning system is preferably a neural network, in particular a deep neural network having a plurality of layers since these layers are able to learn complex relationships in the sensor data and achieve high prediction accuracy. However, it is not limited thereto and can comprise any other suitable machine learning system that fulfills the desired functionality.

In the context of the present invention, the term “sensor signal” can be understood as the digitized representation of the information generated by a sensor, which information reflects the physical measurement quantity of the sensor. Since the method is carried out by a computer, the sensor signal must necessarily be in digital form, typically as an ordered sequence of binary values. The digitization of the analog sensor signal can be carried out, for example, by an analog-to-digital converter (ADC). The digitized sensor signal can take on various formats, including:
Time series: These are sequences of discrete measured values detected over time. Each measured value is represented as a digital value that depicts the measured quantity at a certain point in time.
Digitized images: These can be viewed as two-dimensional arrays of digital values that spatially represent the measured quantity. An example of this is pixel values in a grayscale or color image.
Digital individual values: These represent discrete digital measured values that represent the measured quantity at a specific point in time.
Feature vectors: These can be understood as vectors of digital values that represent various features of the measured signal, such as mean, standard deviation, or frequency components.

The present invention is not limited to specific sensor types and can be used with a variety of sensors whose output signals can be digitized. Examples of sensors that can be used within the scope of this invention are (taking into account the digitization of the signal):
Temperature sensors: Measure the temperature and provide a digitized temperature value.
Pressure sensors: Measure the pressure and provide a digitized value.
Light sensors: Measure the light intensity and provide a digitized value.
Accelerometers: Measure acceleration and provide digitized values. Gyroscopes: Measure the rotational speed and provide digitized values.
Magnetometers: Measure magnetic fields and provide digitized values.
Proximity sensors: Ascertain the presence of objects and provide digitized state values (e.g., 0 or 1).
Image sensors: Capture images that are represented as digital pixel values.
Acoustic sensors (microphones): Capture sound waves, which are represented as digital audio data.
Position sensors: Measure the position and provide digitized coordinates.
Chemical sensors: Measure the concentration of chemical substances and provide digitized values.
Biological sensors: Measure biological parameters and provide digitized values.

This list is not exhaustive, and the present invention can be used with any sensor that provides a digitizable signal that represents the physical quantity to be measured. The present invention is advantageous in particular in applications where the digitized sensor data are noisy, incomplete, or unevenly distributed. The method according to the present invention makes it possible to train a robust and precise machine learning system even under these difficult conditions. In particular, the input can also characterize a plurality of sensor signals, either from sensors of the same type and/or from sensors of different types.

The term “the input characterizes the sensor signal” can be understood to mean that the input comprises the sensor signal or consists of the sensor signal. Alternatively, it is also possible that the input characterizes a result of preprocessing the sensor signal by a corresponding preprocessing method.

The term “quantile of first quality values” can be understood as follows: The first quality values of the bins are sorted, and a quality value that corresponds to a specifiable quantile, for example a 90% quantile, is ascertained as the quality value of the data set.

The term “binning” can be understood as a method for discretizing the values of the sensor signal or the input (x) derived therefrom. This can be understood as dividing the value range of the input variables into a finite number of intervals, so-called “bins.” Each bin represents a certain range of values.

Binning can be performed in various ways, including:
Equidistant binning: Here, the bins are selected such that they all have the same width. This is the simplest form of binning and is particularly suitable for evenly distributed data.
quantile-Based Binning: Here, the boundaries of the bins are selected such that each bin contains the same number of data points. This method is robust against outliers and is well suited for unevenly distributed data.

The number of bins can be understood as a hyperparameter of binning. The optimal number of bins depends on the application and the properties of the data and can be ascertained through experimentation or cross-validation.

In the context of the present invention, binning can be applied to the raw values of the sensor signal or to features derived therefrom. It can also be multidimensional, i.e., a plurality of input variables can be binned simultaneously. Advantageously, this makes it possible to detect complex relationships between the input variables. For example, in the case of two-dimensional binning, the temperature and pressure could in each case be divided into their own bins, creating a matrix of bins.

In the context of the present invention, the term “quality value” can be understood as a numerical measure that characterizes the suitability or quality of a data set, or a part thereof (for example, a bin), for training and/or testing a machine learning system. In particular, the quality value can be understood as a measure of how well the data set, or part of the data set, represents the desired relationship between inputs (x) and outputs (y). A lower quality value can indicate higher quality, suitability or representativeness.

The quality value can depict various aspects of data quality, including:
Representativeness: How well the data set, or a part thereof, covers the relevant input space. A high quality value could, for example, indicate insufficient coverage.
Consistency: How much the actual outputs (y) in the data set deviate from the desired outputs. A high quality value could indicate inconsistent or noisy data.
Variance: How much the actual outputs (y) in the data set vary within a bin.
Prediction accuracy: How well a model trained on the data set can predict the outputs (y) for new, unseen inputs (x). A high quality value could indicate limited generalization capability.

The specific calculation of a quality value can be based on various metrics and can refer to the entire data set or parts thereof, such as bins.

The following is an example of how to calculate a quality value for a bin:
Ascertaining the deviations: For each input (x) in the bin, the deviation of the corresponding actual output (y) from the desired output is calculated. For example, the absolute value of the difference, the squared difference or other suitable functions can be used as a measure of deviation.
Aggregation of deviations: The deviations of all inputs (x) in the bin are aggregated in order to obtain a single value that represents the overall quality of the bin. Possible aggregation functions are:
Mean: The sum of the deviations divided by the number of inputs in the bin.
Median: The middle value of the sorted deviations.

The value calculated in this way represents the quality value for the particular bin.

The present invention is not limited to specific quality metrics or calculation methods and can be used with a variety of metrics and methods that can evaluate the quality of a data set for training and/or testing a machine learning system. The choice of metric and calculation method can depend on factors such as the type of machine learning problem (e.g., classification or regression), the properties of the data set and the specific requirements of the application, and can be understood as a hyperparameter of the method.

However, various approaches may be taken into consideration for ascertaining the desired value:
Existing reference data: In some cases, reference data may already exist that contain the desired outputs for certain inputs. This reference data can come from sources such as measurements, simulations, or manual annotations. In particular, the inputs of the data set can also be fed to a further, already trained machine learning system, wherein the further machine learning system then ascertains the desired outputs. In this case, the further machine learning system can be understood as an oracle or reference system.
Expert knowledge: The desired value can also be defined through expert knowledge. For example, an expert can use their specialist knowledge to specify the desired output for certain inputs.
Physical models: In some applications, physical models can be used to calculate the desired output. For example, a physical model could predict the ideal temperature of a motor under certain operating conditions.
Calculation from other quantities: The desired value can also be calculated from other quantities available in the data set. For example, the desired speed of a vehicle could be calculated from its current position and the desired arrival time.
Combining different methods: It is also possible to combine different methods to ascertain the desired value. For example, a combination of reference data and expert knowledge could be used.

Advantageously, by considering individual bins in particular, the data quality can be assessed in a more differentiated and detailed manner than with conventional, global metrics. This makes a better evaluation of the data set possible with respect to its suitability for training or testing the machine learning system.

In various advantageous embodiments, it is possible to ascertain a second quality value using a loss function, wherein the loss function is a squared error loss function, a cross entropy loss function, a hinge loss function, a Huber loss function, an L1 loss function, or an L2 loss function.

The advantages of each loss function are as follows:
Cross-entropy loss function: Ideal for classification problems, in particular with a plurality of classes. It measures the discrepancy between the predicted probability distribution and the true distribution, thus promoting convergence towards a precise classification probability.
Hinge loss function: Often used in support vector machines. It focuses on the data points that are closest to the decision boundary, thus maximizing the separation margin between the classes.
L1 error (absolute error): Shows high robustness against outliers since it penalizes large errors less than MSE does. This is particularly advantageous for noisy data or data with outliers.
L2 error (squared error—MSE): Particularly suitable for regression problems with continuous target variables. The quadratic term penalizes large errors more severely, which leads to a focus on minimizing significant deviations. It is also continuously differentiable, which facilitates the application of gradient-based optimization methods.

In summary, each loss function offers specific advantages for different problems and data properties.

In various preferred embodiments of the present invention, it is possible that, for the binning of the values of the sensor signal, the values are normalized to a specifiable numerical range, preferably from −1 to 1, in the binning step, or that the value of the sensor signal is already normalized to the specifiable numerical range when the input is provided.

This is advantageous since sensor data can have different units and measurement ranges. Normalizing to a uniform numerical range ensures that all input data are considered on the same scale. This prevents features with larger numerical values from dominating features with smaller numerical values and improves the comparability of the data. Normalization allows the model parameters to be learned faster and more effectively, which leads to better performance and generalization capability of the machine learning system.

In various preferred embodiments of the present invention, it is possible to divide the numerical range into equidistant bins.

Advantageously, equidistant binning is computationally efficient, both in creating the bins and in assigning the data points to the bins. This accelerates the training process of the machine learning system and allows the method to be used in repeated iterations of iterative optimization methods, such as stochastic gradient descent.

In various embodiments of the present invention, it is possible for the input to characterize a plurality of sensor signals.

Here, the value range of each input variable, which is derived from a separate sensor signal, can advantageously be divided into bins. The combination of bins for all input variables then spans a multidimensional space in which each region is represented by a unique combination of bins. The number of bins per input dimension can also be chosen differently.

In various example mbodiments of the present invention, it is possible that the machine learning system is a virtual sensor.

In the context of this present invention, the term “virtual sensor” can be understood as a software-based model that mimics the function of a physical sensor. Instead of directly measuring a physical quantity, a virtual sensor estimates this quantity based on the measured values of other, actually existing sensors and/or further available data. For this purpose, it uses a trained machine learning system that has learned the relationship between the available data and the quantity to be estimated. A concrete example of a virtual sensor in the context of this invention is the estimation of the engine temperature in a vehicle. Instead of installing an expensive and potentially difficult-to-access temperature sensor directly on the engine, a virtual sensor could estimate the engine temperature based on more readily available measurement quantities. Exemplary inputs for the virtual sensor include the rotational speed of the engine, the coolant temperature, the ambient temperature, the engine load condition (e.g., torque), and/or the time since the last engine start.

In various example embodiments of the present invention, it is possible that the input characterizes a position of a robot arm and the output characterizes a combination of positions of actuators of the robot arm, wherein the positions are assumed by the robot arm when the positions of the actuators are set.

Instead of calculating the joint angles of the robot by means of complex inverse kinematics, the machine learning system can advantageously learn the relationship between the desired position of the robot arm and the necessary actuator settings. The desired position, defined for example by Cartesian coordinates and orientation of an endpoint of the robot arm, e.g., a gripper, serves as input for the virtual sensor. In particular, the output of the virtual sensor can consist of, or comprise, the combination of the positions or settings of the actuators, for example, the angles of the individual joints that bring the robot arm into the desired position. The virtual sensor thus acts as an inverse kinematic model trained through machine learning. In order to train this virtual sensor, training data can initially be collected by having the robot arm assume different positions and recording the corresponding actuator settings. Subsequently, the input (desired position) and/or the output data (actuator settings) can be normalized and binned as described above. If the position of the robot arm is multidimensional, multidimensional binning is used. These prepared data are then used to train the machine learning system, for example a neural network. Due to the use of the maximum loss value in the training process, it is ensured that the virtual sensor reliably estimates the actuator settings even with unfavorable input data, such as at the edge of the operating range of the robot. During operation, the virtual sensor receives the desired position of the robot arm as input and provides the corresponding actuator settings as output, which are then used to control the robot arm. The advantages of this approach lie in the simplified control of the robot arm since no complex inverse kinematics need to be calculated. Additionally, the training with the maximum loss value increases the robustness of the virtual sensor against inaccuracies and variations in the input data. The virtual sensor can also adapt to changes in the robot system by being retrained with new data. Advantageously, estimating the actuator settings using the virtual sensor is faster than analytically calculating the inverse kinematics.

A robot arm can also be understood to be, in particular, an arm of an excavator, to which the above example is equivalently applicable.

In preferred example embodiments of the present invention, it is also possible that the outputs (y) are the result of processing the inputs (x) by the machine learning system (60).

The embodiments can be understood as testing the machine learning system. In other words, the outputs of the machine learning system are used as a basis for evaluation, and the behavior of the machine learning system is thus tested. Advantageously, this test does not provide a global measure of the machine learning system across the entire data set but allows, by dividing the data set into bins, a significantly finer investigation with respect to the regions (in the sense of bins) in which the machine learning system cannot make sufficiently good predictions.

In further preferred embodiments of the present invention, it is possible that, in the step of ascertaining (104) the quality value of the data set, the maximum quality value or the quantile is determined from the bins to which at least a specifiable number of inputs (x), for example at least 10 inputs (x), are assigned.

In other words, in these embodiments, only those bins are considered to which “sufficient” inputs have been assigned, wherein sufficient is defined by the specifiable number. The specifiable number can be understood as a hyperparameter of the method. However, the inventors were able to determine that bins having at least 10 assigned inputs provide good results.

Advantageously, by selecting sufficiently filled bins, the quality can be better evaluated since bins having individual outliers do not matter.

In a further aspect, the present invention relates to a method for training a machine learning system, comprising the steps of:
a. Ascertaining a quality value of a data set according to one of the above-described embodiments;
b. If the quality value reaches or exceeds a predefined threshold value:
   Training the machine learning system with the data set;
c. Otherwise:
   Ascertaining a bin that corresponds to the ascertained quality value;
   Ascertaining at least one further input and a corresponding output, wherein the input lies within the bin;
Ascertaining an extended data set by adding the input and output to the data set;
Repeating steps a and b or c with the extended data set as the data set.

Advantageously, according to an example embodiment of the present invention, the method for training the machine learning system allows for an incremental improvement of the training data set until the data set is “good enough” to be used to train the machine learning system.

The combination of at least one further input and output can be achieved in particular by a targeted recording of a desired input in the real world. In particular, a test environment can be set up for this purpose, allowing further input to be recorded. Further output can then be provided, for example, by annotating the input by a human expert.

Alternatively, it is also possible to ascertain the at least one further input and output by means of a computer-aided simulation. For example, a physical model of input and output can be used to create a virtual environment, by means of which the input and output can be ascertained, or in other words, synthesized.

In a further aspect, the present invention relates to a training device that is configured to carry out the training method of the present invention.

In a further aspect, the present invention relates to a computer program that is configured to carry out one of the above-mentioned methods of the present invention when executed by a processor.

In a further aspect, the present invention relates to a machine-readable storage medium on which the computer program is stored.

Example embodiments of the present invention are explained in detail below with reference to the figures.

### BRIEF DESCRIPTION OF THE DRAWINGS

FIG. 1A schematically shows a method for ascertaining a quality value, according to an example embodiment of the present invention.

FIG. 1B schematically shows a method for training a machine learning system, according to an example embodiment of the present invention.

FIG. 2 shows a training system, according to an example embodiment of the present invention.

FIG. 3 schematically shows a structure of a control system for controlling an actuator, according to an example embodiment of the present invention.

FIG. 4 schematically shows an exemplary embodiment for controlling an at least partially autonomous robot, according to an example embodiments of the present invention.

### DETAILED DESCRIPTION OF EXAMPLE EMBODIMENTS

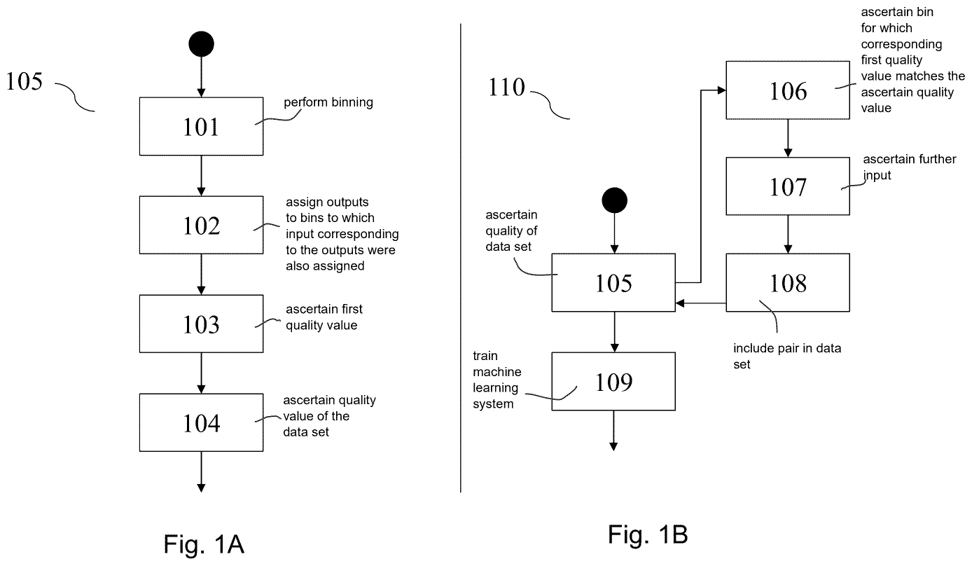

FIG. 1A schematically shows a flowchart with respect to a computer-implemented method (105) for ascertaining a quality value of a data set (black dot in the figure symbolizes the start of the method). The data set comprises a plurality of inputs and one output corresponding to one input in each case. The inputs and outputs corresponding to one another in each case can be understood as data pairs. An input of a data pair in each case characterizes at least one sensor signal, wherein the output characterizes a classification or regression result assigned to the sensor signal, i. e., the result of a regression analysis. The inputs and outputs are preferably in numerical form and in the form of a mathematical structure, e. g., in the form of a vector, a matrix, or a tensor. The numerical values of the inputs in each case represent values of the sensor signals characterized by the inputs.

In a first step (101), a binning of the numerical values of the input is performed. Preferably, an equidistant binning of the inputs is performed. Preferably, the lower and upper limits of the binning can also be ascertained based on the data set. For example, in the particular dimension of an input, the lowest value of the inputs can be used as the lower limit of the binning and the highest value of the inputs as the upper limit of the binning.

In a second step (102), the outputs are in each case assigned to the bins to which the inputs corresponding to the outputs were also assigned.

In a third step (103), a first quality value is ascertained for the bins of the binning in each case. For ascertaining the first quality value, second quality values are determined in each case, wherein, in each case, a second quality value characterizes a deviation of an output assigned to the bin from a desired output. The desired output can be ascertained as described further above. The deviation can be expressed numerically by means of a suitable metric, wherein this numerical value can be understood as a second quality value. One of the metrics mentioned above can be used as the metric. The second quality values ascertained for a bin in this way can subsequently be aggregated in order to ascertain the first quality value. In particular, an average or median of the second quality values can be provided as the first quality value through aggregation.

In a fourth step (104), the quality value of the data set is ascertained. For this purpose, the numerically smallest first quality value of the different bins is provided as the quality value of the data set. The quality of the data set is output as a result of the method (last arrow from 104).

FIG. 1B schematically shows a flowchart with respect to a computer-implemented method (110) for training a machine learning system (black dot in the figure symbolizes the start of the method). The machine learning system is preferably configured to accept an input of the data set and to ascertain an output that characterizes a classification and/or a regression result. The machine learning system is preferably a neural network, for example a multi-layer perceptron, a convolutional neural network, or a transformer. The method can use common neural network architectures.

In a first step of the method (105), the quality of a data set is preferably ascertained according to the exemplary embodiment of FIG. 1A. In other words, a quality value is ascertained according to one of the methods described above.

If the ascertained quality value reaches or exceeds a predefined threshold value, the machine learning system is trained by means of the data set in a further step (109). This can be understood in particular to mean that the data set can be used as a training data set for the machine learning system. Since the data set contains pairs of inputs and outputs, these pairs can be used directly for supervised training. In particular, stochastic algorithms, such as SGD or Adam, can be used as training algorithms.

If the ascertained quality value is below the threshold value, the data set is enriched in the method shown in FIG. 1B, in order to improve the quality. For this purpose, in one step (106), the bin is ascertained for which the corresponding first quality value matches the ascertained quality value. In a further step (107), a further input is ascertained that lies within the bin. For this purpose, the bin can be investigated with respect to its boundaries and an input can be ascertained that lies within the boundaries of the bin. This input ascertained in this way can then be annotated according to one of the above-mentioned methods. In this way, a further pair of input and output can be ascertained. In a further step (108), the pair is included in the data set, and an extended data set is thus ascertained. A quality value can then be ascertained for this extended data set. In this way, the data set can be enriched more and more iteratively. It is also possible that, in at least one of the iterations, a plurality of input and output pairs are ascertained and included in the data set.

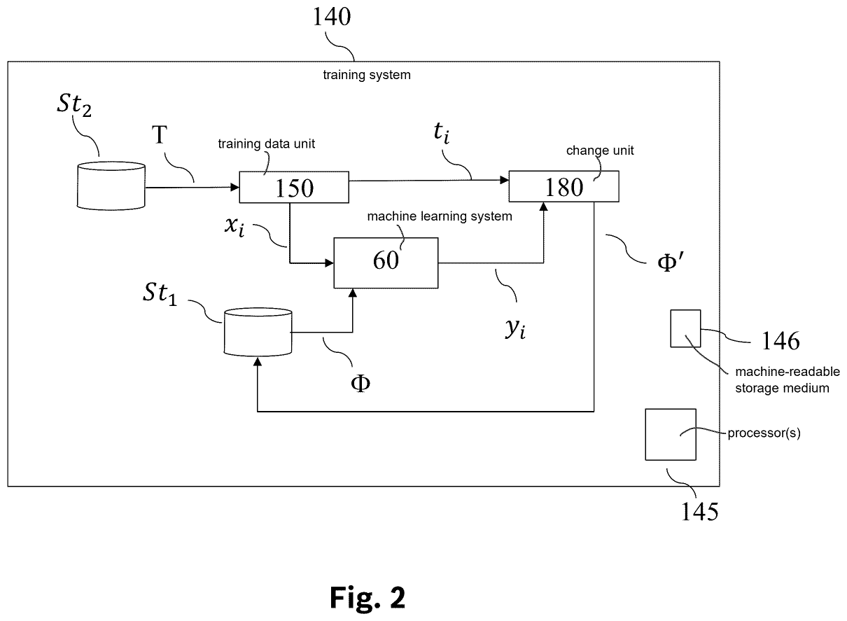

FIG. 2 shows an exemplary embodiment of a training system (140) for training the machine learning system (60) by means of the training data set (T). The training data set (T) comprises a plurality of inputs (xᵢ) that are used to train the machine learning system (60), wherein the training data set (T) further comprises, for each input (xᵢ), a desired output (tᵢ) that corresponds to the input (xᵢ) and characterizes a classification and/or a regression result of the input (xᵢ).

For the training, a training data unit (150) accesses a computer-implemented database (St₂), wherein the database (St₂) provides the training data set (T). The training data unit (150) ascertains from the training data set (T), preferably randomly, at least one input (xᵢ) and the desired output (tᵢ) corresponding to the input (xᵢ), and transmits the input (xᵢ) to the machine learning system (60). The machine learning system (60) ascertains an output (yᵢ) on the basis of the input (xᵢ).

The desired output (tᵢ) and the ascertained output (yᵢ) are transmitted to a change unit (180).

Based on the desired output (tᵢ) and the ascertained output (yᵢ), the change unit (180) then determines new parameters (Φ′) for the machine learning system (60). For this purpose, the change unit (180) compares the desired output (tᵢ) and the ascertained output (yᵢ) by means of a loss function. The loss function ascertains a first loss value that characterizes to what extent the ascertained output (yᵢ) deviates from the desired output (tᵢ). In the exemplary embodiment, a negative logarithmic plausibility function (negative log-likelihood function) is selected as the loss function. In alternative exemplary embodiments, other loss functions are also possible.

Furthermore, it is possible that the ascertained output (yᵢ) and the desired output (tᵢ) in each case comprise a plurality of sub-signals, for example in the form of tensors, wherein, in each case, a sub-signal of the desired output (tᵢ) corresponds to a sub-signal of the ascertained output (yᵢ). For example, it is possible that the machine learning system (60) is designed for object detection, and that a first sub-signal in each case characterizes a probability of occurrence of an object with respect to a part of the input (xᵢ), and a second sub-signal characterizes the exact position of the object. In the event that the ascertained output (yᵢ) and the desired output (tᵢ) comprise a plurality of corresponding sub-signals, a second loss value is preferably ascertained for each corresponding sub-signal by means of a suitable loss function and the ascertained second loss values are suitably combined to form the first loss value, for example via a weighted sum.

The change unit (180) ascertains the new parameters (Φ′) on the basis of the first loss value. In the exemplary embodiment, this is done by using a gradient descent method, preferably Stochastic Gradient Descent, Adam, or AdamW. In further exemplary embodiments, the training can also be based on an evolutionary algorithm or second-order optimization.

The ascertained new parameters (Φ′) are stored in a model parameter memory (St₁). Preferably, the ascertained new parameters (Φ′) are provided as parameters (Φ) to the machine learning system (60).

In further, preferred exemplary embodiments, the described training is repeated iteratively for a predefined number of iteration steps or repeated iteratively until the first loss value falls below a predefined threshold value. Alternatively or additionally, it is also possible that the training is terminated when an average first loss value for a test or validation data set falls below a predefined threshold value. In at least one of the iterations, the new parameters (Φ′) determined in a previous iteration are used as parameters (Φ) of the machine learning system (60).

Furthermore, the training system (140) may comprise at least one processor (145) and at least one machine-readable storage medium (146) containing instructions that, when executed by the processor (145), cause the training system (140) to perform a training method according to one of the aspects of the present invention.

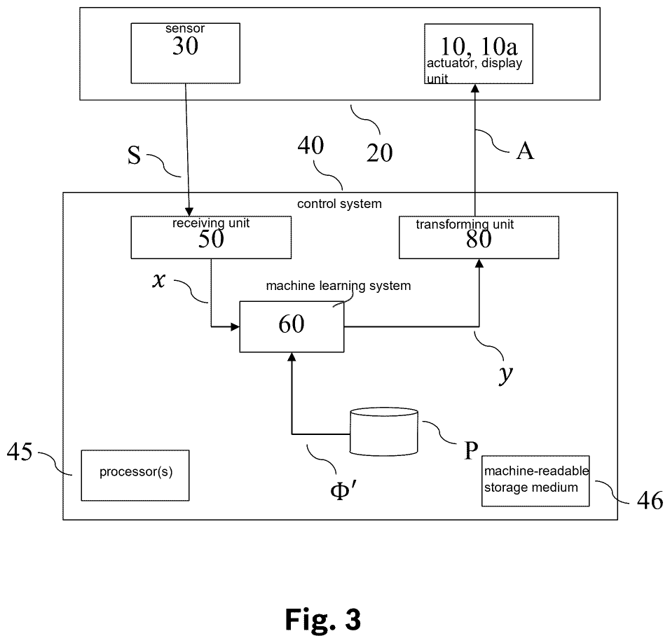

FIG. 3 shows a control system (40) that ascertains control signals (A) for an actuator by means of the machine learning system (60).

At preferably regular time intervals, an environment (20) of the actuator (10) is detected using a sensor (30), in particular an imaging sensor such as a camera sensor, which can also be provided by a plurality of sensors, for example a stereo camera. The sensor signal(S)—or, in the case of a plurality of sensors, one sensor signal(S) each—of the sensor (30) is transmitted to the control system (40). The control system (40) thus receives a sequence of sensor signals(S). The control system (40) ascertains control signals (A) therefrom, which are transmitted to the actuator (10).

The control system (40) receives the sequence of sensor signals (S) from the sensor (30) in an optional receiving unit (50), which converts the sequence of sensor signals(S) into a sequence of inputs (x) (alternatively, the sensor signal(S) can also be adopted directly as the inputs (x)). The input (x) can, for example, be a portion or a further processing of the sensor signal (S). In other words, the input (x) is ascertained depending on the sensor signal(S). The sequence of inputs (x) is fed to the machine learning system (60).

The machine learning system (60) is preferably parametrized by parameters (Φ) that are stored in a parameter memory (P) and are provided by the latter.

The machine learning system (60) ascertains outputs (y) from the input signals (x). The outputs (y) are fed to an optional transforming unit (80), which ascertains control signals (A) therefrom, which are fed to the actuator (10) in order to control the actuator (10) accordingly.

The actuator (10) receives the control signals (A), is controlled accordingly and performs a corresponding action. Here, the actuator (10) can comprise a control logic (not necessarily structurally integrated), which ascertains, from the control signal (A), a second control signal with which the actuator (10) is then controlled.

In further embodiments, the control system (40) comprises the sensor (30). In still further embodiments, the control system (40) alternatively or additionally also comprises the actuator (10).

In further preferred embodiments, the control system (40) comprises at least one processor (45) and at least one machine-readable storage medium (46) on which instructions are stored that, when executed on the at least one processor (45), cause the control system (40) to perform the method according to the present invention.

In alternative embodiments, a display unit (10a) is provided as an alternative or in addition to the actuator (10).

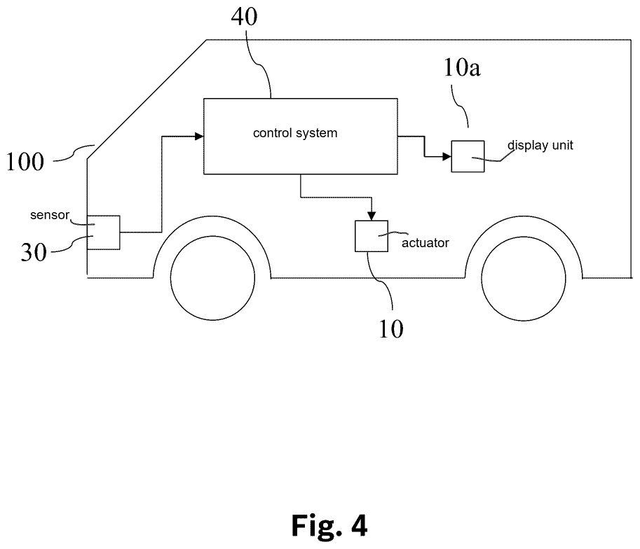

FIG. 4 shows how the control system (40) can be used to control an at least partially autonomous robot, in this case an at least partially autonomous motor vehicle (100).

The sensor (30) can, for example, be a sensor that is preferably arranged in the robot (100) and performs measurements of a component of the robot (100). The component can, for example, be an injection valve of an internal combustion engine of the vehicle (100), wherein the sensor is a piezo sensor that is fastened to the valve. A voltage measured by means of the piezo sensor can be used as at least part of the input (x) of the machine learning system (60), wherein the machine learning system (60) is configured to predict an injection quantity of the valve based on the voltage. In order to train the machine learning system (60), corresponding pairs of voltages of the piezo sensor and injection quantity can be measured on a test device.

Alternatively, the component can be an electric motor of the robot (100), for example a drive motor of the robot (100) for locomotion. The machine learning system can, in particular, predict a temperature of a stator or rotor of the motor as the output (y). As inputs, a load of the motor, a voltage of the motor, a current consumption of the motor, and a temperature measured at a location other than the rotor or the stator can be used.

The actuator (10), which is preferably arranged in the robot (100), can, for example, be a brake, a drive or a steering system of the robot (100), or the above-mentioned valve. The control signal (A) can be selected, for example, such that it controls the valve, depending on the actually injected quantity, to inject more or less fuel into the engine, depending on the injection quantity characterized by the output (y). If the output (y) characterizes a temperature of a stator or rotor, the robot (100) can be brought into a safe state if the temperature reaches or exceeds a specifiable threshold value. The safe state may be, for example, a shutdown of the robot or holding the robot in a safe zone (for example, a shoulder in the case of an at least partially autonomous motor vehicle).

Alternatively or additionally, the control signal (A) can be used to control the display unit (10a) and, for example, to display the identified injection quantity or temperature. It is also possible for the display unit (10a) to be controlled with the control signal (A) in such a way that it outputs an optical or acoustic warning signal if it is ascertained that the stator or the rotor is in danger of overheating. The warning by means of a warning signal can also be provided by means of a haptic warning signal, for example by a vibration of a steering wheel of the motor vehicle (100).

The term “computer” refers to any device for processing specifiable calculation rules. These calculation rules can be in the form of software, or in the form of hardware, or even in a mixed form of software and hardware.

In general, a plurality can be understood as indexed, i.e., each element of the plurality is assigned a unique index, preferably by assigning consecutive integers to the elements contained in the plurality. Preferably, when a plurality comprises N elements, where N is the number of elements in the plurality, the elements are assigned integers from 1 to N.

1-13. (canceled)

14. A computer-implemented method for ascertaining a quality value of a data set for training and/or testing a machine learning system, wherein the data set includes a plurality of inputs and, for each respective input of the plurality of inputs, an output corresponding to the respective input, wherein each respective input of the plurality of inputs characterizes at least one value of a sensor signal, and each of the corresponding outputs includes a classification and/or a regression result with respect to the respective input, wherein the method comprises the following steps:
ascertaining a binning of the values of the sensor signals of the plurality of the inputs, wherein the respective inputs are assigned to different bins of the binning according to the values of the sensor signals characterized by the respective inputs;
assigning the corresponding outputs to the bins according to the assignment of the respective inputs corresponding to the corresponding outputs;
ascertaining a respective first quality value for each bin of a plurality of bins of the binning, wherein each of the respective first quality value characterizes an average or median of second quality values, wherein each of the second quality values characterizes a deviation with respect to an output assigned to the bin from correspondingly desired outputs; and
acertaining the quality value of the data set, wherein the quality value corresponds to a numerically largest quality value of the first quality values or a quantile of the first quality values.

15. The method according to claim 14, wherein each of the second quality values is ascertained using a loss function, wherein the loss function is a squared error loss function, or a cross entropy loss function, or a hinge loss function, or a Huber loss function, or an L1 loss function, or an L2 loss function.

16. The method according to claim 14, wherein, for the binning of the values of the sensor signal, the values of the sensor signals are normalized to a specifiable numerical range in the binning step, or the values of the sensor signals are already normalized to the specifiable numerical range when the respective inputs are provided.

17. The method according to claim 16, wherein the numerical range is divided into equidistant bins.

18. The method according to claim 14 wherein each of the inputs characterizes a plurality of sensor signals.

19. The method according to claim 14, wherein the machine learning system is a virtual sensor.

20. The method according to claim 14, wherein each of the respective inputs characterizes a position of a robot arm, and the corresponding output correponding to the respective input characterizes a combination of positions of actuators of the robot arm, wherein the positions are assumed by the robot arm when the positions of the actuators are set.

21. The method according to claim 14, wherein the corresponding outputs are results of processing the respective inputs by the machine learning system.

22. The method according to claim 14, wherein, in the step of ascertaining the quality value of the data set, the maximum quality value or the quantile is determined from the bins to which at least a specifiable number of the inputs are assigned.

23. A computer-implemented method for training a machine learning system, comprising the following steps:
a) ascertaining a quality value of a data set, wherein the data set includes a plurality of inputs and, for each respective input of the plurality of inputs, an output corresponding to the respective input, wherein each respective input of the plurality of inputs characterizes at least one value of a sensor signal, and each of the corresponding outputs includes a classification and/or a regression result with respect to the respective input, wherein the ascertaining of the quality value of the data set includes:
ascertaining a binning of the values of the sensor signals of the plurality of the inputs, wherein the respective inputs are assigned to different bins of the binning according to the values of the sensor signals characterized by the respective inputs,
assigning the corresponding outputs to the bins according to the assignment of the respective inputs corresponding to the corresponding outputs,
ascertaining a respective first quality value for each bin of a plurality of bins of the binning, wherein each of the respective first quality value characterizes an average or median of second quality values, wherein each of the second quality values characterizes a deviation with respect to an output assigned to the bin from correspondingly desired outputs, and
acertaining the quality value of the data set, wherein the quality value corresponds to a numerically largest quality value of the first quality values or a quantile of the first quality values;
b) when the quality value reaches or exceeds a predefined threshold value, training the machine learning system with the data set; and
c) when the quality value does not reach or exceed the predefine threshold value:
ascertaining a bin of the binning that corresponds to the ascertained quality value,
ascertaining at least one further input and a corresponding output, wherein the at least one further input lies within the bin,
ascertaining an extended data set by adding the at least one further input and the corresponding output to the data set, and
repeating steps: (i) a, and (ii) b or c, with the extended data set as the data set.

24. A training device configured for training a machine learning system by performing the following steps:
a) ascertaining a quality value of a data set, wherein the data set includes a plurality of inputs and, for each respective input of the plurality of inputs, an output corresponding to the respective input, wherein each respective input of the plurality of inputs characterizes at least one value of a sensor signal, and each of the corresponding outputs includes a classification and/or a regression result with respect to the respective input, wherein the ascertaining of the quality value of the data set includes:
ascertaining a binning of the values of the sensor signals of the plurality of the inputs, wherein the respective inputs are assigned to different bins of the binning according to the values of the sensor signals characterized by the respective inputs,
assigning the corresponding outputs to the bins according to the assignment of the respective inputs corresponding to the corresponding outputs,
ascertaining a respective first quality value for each bin of a plurality of bins of the binning, wherein each of the respective first quality value characterizes an average or median of second quality values, wherein each of the second quality values characterizes a deviation with respect to an output assigned to the bin from correspondingly desired outputs, and
acertaining the quality value of the data set, wherein the quality value corresponds to a numerically largest quality value of the first quality values or a quantile of the first quality values;
b) when the quality value reaches or exceeds a predefined threshold value, training the machine learning system with the data set; and
c) when the quality value does not reach or exceed the predefine threshold value:
ascertaining a bin of the binning that corresponds to the ascertained quality value,
ascertaining at least one further input and a corresponding output, wherein the at least one further input lies within the bin,
ascertaining an extended data set by adding the at least one further input and the corresponding output to the data set, and
repeating steps: (i) a, and (ii) b or c, with the extended data set as the data set.

25. A non-transitory machine-readable storage medium on which is stored a computer program for training a machine learning system, the computer program, when executed by a processor, causing the processor to perform the following steps:
a) ascertaining a quality value of a data set, wherein the data set includes a plurality of inputs and, for each respective input of the plurality of inputs, an output corresponding to the respective input, wherein each respective input of the plurality of inputs characterizes at least one value of a sensor signal, and each of the corresponding outputs includes a classification and/or a regression result with respect to the respective input, wherein the ascertaining of the quality value of the data set includes:
ascertaining a binning of the values of the sensor signals of the plurality of the inputs, wherein the respective inputs are assigned to different bins of the binning according to the values of the sensor signals characterized by the respective inputs,
assigning the corresponding outputs to the bins according to the assignment of the respective inputs corresponding to the corresponding outputs,
ascertaining a respective first quality value for each bin of a plurality of bins of the binning, wherein each of the respective first quality value characterizes an average or median of second quality values, wherein each of the second quality values characterizes a deviation with respect to an output assigned to the bin from correspondingly desired outputs, and
acertaining the quality value of the data set, wherein the quality value corresponds to a numerically largest quality value of the first quality values or a quantile of the first quality values;
b) when the quality value reaches or exceeds a predefined threshold value, training the machine learning system with the data set; and
c) when the quality value does not reach or exceed the predefine threshold value:
ascertaining a bin of the binning that corresponds to the ascertained quality value,
ascertaining at least one further input and a corresponding output, wherein the at least one further input lies within the bin,
ascertaining an extended data set by adding the at least one further input and the corresponding output to the data set, and
repeating steps: (i) a, and (ii) b or c, with the extended data set as the data set.
